(19) United States
(12) Patent Application Publication
(10) Pub. No.: US 2019/0065689 A1
(43) Pub. Date: Feb. 28, 2019

(54) ALERTING USERS TO PREDICTED HEALTH CONCERNS

(71) Applicant: Accenture Global Solutions Limited, Dublin (IE)

(72) Inventors: Laura O`Malley, Dublin (IE); Navdeep Sharma, Dublin (IE); Shane Terence Odlum, Dublin (IE); Rachit Agarwal, Dublin (IE); Gino André Di Paolo, Dublin (IE)

(21) Appl. No.: 15/685,695

(22) Filed: Aug. 24, 2017

(51) Int. Cl. G06F 19/00; H04L 29/08

(52) U.S. Cl. CPC G06F 19/3418; H04L 67/306; G06F 19/3431

(57) ABSTRACT

Implementations are directed to receiving source data comprising data representative of medical events, processing the source data using natural language processing (NLP) techniques to provide a plurality of feature sets, providing event-specific predictive models based on the plurality of feature sets, each event-specific predictive model being specific to a particular medical event, receiving real-time data from data sources, the real-time data being representative of occurring healthcare conditions, processing the real-time data using at least one event-specific predictive model associated with a medical event to provide a predictive output that indicates a likelihood of occurrence of the medical event, and selectively broadcasting electronic messages to remote devices at least partially based on the predictive output, at least one electronic message including data associated with the medical event, and data indicative of information and sources of information for mitigating exposure to the medical event.

### BACKGROUND

Medical events that affect large numbers of a populace (e.g., outbreaks, epidemics) can cost lives, and strain resources. Systems have been developed to recognize the occurrence of such medical events. However, by the time a population may be alerted to the medical event, the medical event is in full swing. Further, communications regarding medical events are lacking in terms of their reach, and/or information provided. For example, in the relatively recent case of a Zika virus outbreak in the State of Florida, in the United States, people were informed about the existence of the outbreak after it had occurred, and largely from news sources. In concern over the virus, people turned to various sources, such as search engines and websites, to search for ways to avoid contracting the virus, symptoms of the virus, and/or treatments for the virus. Some such sources were incomplete, uninformed, misinformed, and/or contradictory with other sources.

### SUMMARY

Implementations of the present disclosure are generally directed to predicting health concerns. More particularly, implementations of the present disclosure are directed to predicting health concerns, such as future outbreaks, using predictive models, and real-time data, and alerting users to predicted health concerns, and remedial actions.

In some implementations, actions include receiving source data including data representative of medical events, processing the source data using natural language processing (NLP) techniques to provide a plurality of feature sets, providing event-specific predictive models based on the plurality of feature sets, each event-specific predictive model being specific to a particular medical event, receiving real-time data from data sources, the real-time data being representative of occurring healthcare conditions, processing the real-time data using at least one event-specific predictive model associated with a medical event to provide a predictive output that indicates a likelihood of occurrence of the medical event, and selectively broadcasting electronic messages to remote devices at least partially based on the predictive output, at least one electronic message including data associated with the medical event, and data indicative of information and sources of information for mitigating exposure to the medical event. Other implementations of this aspect include corresponding systems, apparatus, and computer programs, configured to perform the actions of the methods, encoded on computer storage devices.

These and other implementations can each optionally include one or more of the following features: the predictive output is compared to one or more thresholds, and the electronic message is broadcast in response to the predictive output exceeding at least one threshold; an electronic message is provided as one of a first type and a second type based on at least one value of the predictive output; the one or more event-specific predictive models are provided based on training data; the source data is provided in two or more disparate formats, and is processed to a standardized format; and the one or more event-specific predictive models are trained further based on one or more of updates to a knowledge base, and the predictive output.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 depicts an example high-level architecture in accordance with implementations of the present disclosure.

FIG. 2 depicts an example architecture in accordance with implementations of the present disclosure.

FIG. 3 depicts an example process that can be executed in accordance with implementations of the present disclosure.

### DETAILED DESCRIPTION

Implementations of the present disclosure are generally directed to predicting health concerns. More particularly, implementations of the present disclosure are directed to predicting medical events, such as future outbreaks, using predictive models, and real-time data, and alerting users to predicted medical events, and remedial actions. As described in further detail herein, implementations of the present disclosure include actions of receiving source data including data representative of medical events, processing the source data using natural language processing (NLP) techniques to provide a plurality of feature sets, providing event-specific predictive models based on the plurality of feature sets, each event-specific predictive model being specific to a particular medical event, receiving real-time data from data sources, the real-time data being representative of occurring healthcare conditions, processing the real-time data using at least one event-specific predictive model associated with a medical event to provide a predictive output that indicates a likelihood of occurrence of the medical event, and selectively broadcasting electronic messages to remote devices at least partially based on the predictive output, at least one electronic message including data associated with the medical event, and data indicative of information and sources of information for mitigating exposure to the medical event.

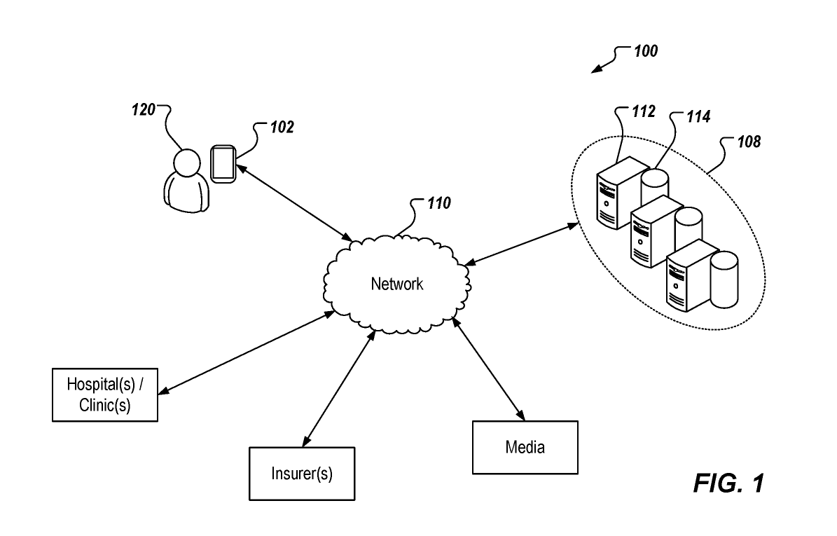

FIG. 1 depicts an example high-level architecture 100 in accordance with implementations of the present disclosure. The example architecture 100 includes a device 102, a server system 108, and a network 110. In some examples, the network 110 includes a local area network (LAN), wide area network (WAN), the Internet, a cellular telephone network, a public switched telephone network (PSTN), a private branch exchange (PBX), a next generation network (NGN), or any appropriate combination thereof, and connects web sites, devices (e.g., the device 102), and server systems (e.g., the server system 108). In some examples, the network 110 can be accessed over a wired and/or a wireless communications link. For example, mobile devices, such as smartphones can utilize a cellular network to access the network 110.

In the depicted example, the server system 108 includes at least one server system 112, and data store 114 (e.g., database). In some examples, at least one server system 112 hosts one or more computer-implemented services that users can interact with using devices. For example, the server system 112 can host an AI-based digital agent in accordance with implementations of the present disclosure. In some examples, the device 102 can each include any appropriate type of computing device such as a desktop computer, a laptop computer, a handheld computer, a tablet computer, a personal digital assistant (PDA), a cellular telephone, a network appliance, a camera, a smartphone, a telephone, a mobile phone, an enhanced general packet radio service (EGPRS) mobile phone, a media player, a navigation device, an email device, a game console, or an appropriate combination of any two or more of these devices, or other data processing devices.

In accordance with the present disclosure, the server system 108 can host a medical event prediction and notification service, which receives data, and predicts a likelihood of occurrence of one or more medical events, as described herein. In some examples, notifications can be transmitted to one or more entities, as also described in further detail herein. For example, the device 102 is used by a user 120. In accordance with the present disclosure, the device 102 can receive a notification regarding a medical event, which enables the user 120 to take appropriate action. For example, the user 120 can include a citizen that could be affected by the medical event, and the notification can inform the user of the potential for the medical event, as well as provide information (or links to information) on how to mitigate susceptibility to the medical event (e.g., mitigate exposure to a viral outbreak).

As introduced above, by the time a population may be alerted to a medical event, the medical event is occurring, and communications regarding medical events are lacking in terms of their reach, and/or information provided. For example, people turn to various sources, such as search engines and websites, to search for ways to avoid exposure to the medical event, symptoms of the medical event (e.g., virus), and/or treatments. Some such sources are incomplete, uninformed, misinformed, and/or contradictory with other sources.

In view of this, implementations of the present disclosure are directed to predicting the likelihood of, and/or the actual occurrence of one or more medical events based on one or more event-specific predictive models. Features associated with a type of medical event (e.g., Zika virus, seasonal flu, bird flu, swine flu) are extracted, and are used to train an event-specific predictive model. For example, natural language processing (NLP) techniques can be used to extract features from one or more source documents. Example features can include diseases, viruses, symptoms, treatments, incubation periods, and geography (e.g., susceptible locations). Example source documents can include historical medical records, which can include, for example, medical charts, electronic medical records (EMRs), medical texts (e.g., text books, publications), and the like. Physical sources, such as physical medical records or charts can be converted to digital data for processing (e.g., scanned in as PDFs and processed using OCR). For each medical event, a set of features can be provided.

In some implementations, a knowledge base is provided, and is continuously updated. In some examples, the knowledge base includes information about past outbreaks, growth of epidemics with time, as well as geographically. The knowledge base will also maintain information on mapping the epidemics to patients' medical history to enable the predictive model to identify patients with a relatively higher probability of being affected (e.g., children, elderly, male, female).

In some implementations, an event-specific predictive model is trained based on the set of features (e.g., using supervised learning, unsupervised learning). Multiple predictive models can be provided, each being specific to a particular medical event (e.g., a flu predictive model, a bird flu predictive model, a swine flu predictive model, a Zika predictive model). Each predictive model provides a likelihood of an occurrence of the respective medical event (e.g., 0%-100% probability that there will be a virus X outbreak). Each predictive model provides a likelihood and timeline of the respective medical event (e.g., 0%-100% probability that there will be a virus X outbreak in the next Y days).

In some implementations, each predictive model is continuously, or periodically updated based on a feedback loop. For example, a medical event data in the knowledge base can be used to continuously/periodically update a respective predictive model (e.g., Zika-related data can be used to retrain a Zika predictive model). Other sources of feedback data can be provided for retraining the predictive models. For example, data from a central agency (e.g., a governmental agency, such as the Center for Disease Control (CDC)) can be provided. As another example, an output of a decision function, described in further detail herein, can be provided as feedback.

In accordance with implementations of the present disclosure, an event-specific predictive model receives real-time data representative of conditions that may be relevant to a particular medical event. Example real-time data can include intake forms (e.g., hospital/clinic patient intake forms), medical charts, insurance claims, and the like. For example, healthcare providers (e.g., doctors, clinics, hospitals) can provide intake forms, medical charts, and the like to a real-time data collection system, which can process the information to provide one or more data sets for evaluation by one or more event-specific predictive models. As another example, health insurance providers can provide insurance claim information to the real-time data collection system. Enterprises, such as healthcare providers and health insurance providers may be motivated to submit real-time information in return for receiving results of the event-specific predictive model(s). For example, such enterprises can use the results to help prevent impending medical events (e.g., stop an outbreak before it happens), mitigate losses due to a medical event (e.g., stop the spread of a virus), for resource planning purposes (e.g., staffing and placing medical equipment in particular locales), and the like.

In some implementations, any personally identifiable information (PII) (e.g., name, birthdate, social security number, health insurance information, street address) can be removed from the data. For example, any PII can be removed prior to submission to the real-time data collection system, or can be removed by the real-time data collection system. In this manner, patient anonymity, and data security can be preserved. Some data, however, may still be preserved, such as demographic data (e.g., gender, age), and geographic information (e.g., street, postal code), for example.

In some implementations, for known medical events (e.g., virus, disease), a statistical classification model will be used that will give a probability of the event X breaking out in the next Y time (e.g., days, weeks, months). An anomaly detection model can be used to allow flagging of potential outbreaks of new or unknown events. For example, a period of anomalous features can cause a flag to be raised, after which experts can do further analysis to determine whether there is a risk of an outbreak. Both models are provided using historical data and knowledge of event outbreaks as well as external sources (e.g. social media, CDC, Google Trends). The features extracted can be provided as aggregate features over all sources (e.g., medical charts) in a period of time T (e.g., days, weeks, months) before an outbreak (e.g. number of charts by demographic, total number of charts, number of occurrences of X treatment or Y disease).

In some implementations, output of the event-specific predictive model can trigger one or more actions. Example actions can include providing alerts, and/or reports to stakeholders (e.g., institutions (schools, universities, transportation service providers, media outlets), health insurance providers, healthcare providers, government institutions (e.g., city council, state government, federal government (CDC))). An action can include directly alerting people (e.g., residents of a particular locale that may be imminently/currently affected by the medical event, or patients identified by the model as more likely to be affected by a particular disease). For example, an alert can be broadcast to mobile devices (e.g., a text message broadcast to mobile telephones of a populace of one or more locales (similar to Amber-alerts)). An alert can include example information regarding the potential for a medical event to occur, actual occurrence of a medical event, areas affected, symptoms, treatments, locations for treatment, nearest locations for treatment based on a person's location, and the like.

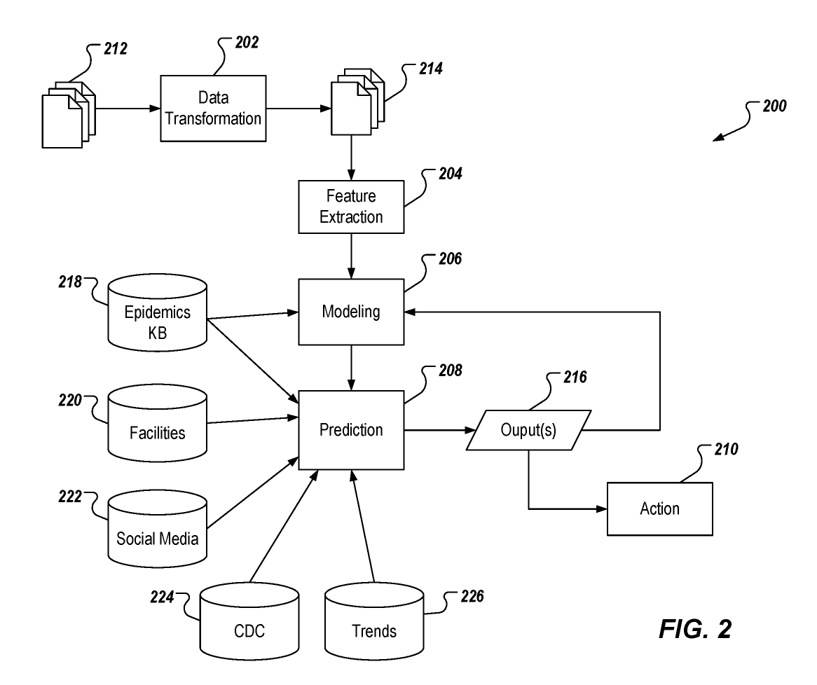

FIG. 2 depicts an example architecture 200 in accordance with implementations of the present disclosure. In some examples, components of the example architecture 200 can be hosted on one or more server systems (e.g., the server system 108 of FIG. 1). In the depicted example, the example architecture 200 includes a data transformation module 202, a feature extraction module 204, a modeling module 206, a predictions module 208, and an action module 210.

In some implementations, the data transformation module 202 receives source documents 212. Each of the source documents is provided in a computer-readable format (e.g., portable document format (PDF)). Example source documents can include, without limitation, historical medical records (e.g., medical charts, EMRs, medical texts). In some examples, physical sources, such as physical medical records, or charts can be converted to digital data to be provided as a source document 212. In some examples, the data transformation module 202 processes the source documents 212 to provide input documents 214 in a standardized format. An example standardized format includes a text format (e.g., .TXT). For example, a source document provided as a PDF file, can be used to provide an input document as a TXT file using optical character recognition (OCR) executed over the source document.

In some examples, the input documents 214 are processed to remove any personally identifiable information (PII). Example PII can include, without limitation, name, address, and social security number (SSN). It is contemplated, however, that demographic information, if any, remain in the input documents 214. Example demographic information can include, without limitation, age, gender, and race.

In some implementations, the feature extraction module 204 receives, and processes the input documents 214 to provide a set of features for each medical event that is to be modeled. In some examples, a feature can be described as an attribute, or a parameter that may be related in some degree to the medical event. In some implementations, the feature extraction module 204 processes the input documents 214 using one or more natural language processing (NLP) techniques to provide sets of features. More particularly, NLP can be used to extract features from the input documents 214, such as, symptoms, viruses, diseases, treatments, geography, and demographic information. Multiple NLP techniques are known in the art. Example NLP techniques include, without limitation, name entity recognition, entity relationships, entity linking, topic modeling, and text classification. Implementations of the present disclosure can utilize any appropriate NLP technique. Consequently, a detailed discussion of any particular NLP technique is foregone.

In some examples, the feature extraction module 204 provides a first set of features relevant to a first type of medical event (e.g., Zika), and a second set of features relevant to a second type of medical event (e.g., flu). In some examples, feature extraction can be provided as a multi-step process, which includes feature construction (e.g., providing a feature as a representation, such as a vector; normalizing features; dimensionality reduction), and feature selection (e.g., selecting features that are relevant to the particular medical event). In general, feature selection includes identifying features, and/or combinations of features that provide accurate prediction of the medical event (e.g., including features that are relevant to the medical event, removing features that are less (or not at all) relevant to the medical event). Multiple techniques for executing feature selection are known in the art. Example feature selection techniques can involve, without limitation, word embeddings (e.g., Word2Vec), bag-of-words (BOW), occurrences of extracted entities, and temporal and geospatial aggregations of occurrences across documents. Implementations of the present disclosure can utilize any appropriate feature selection technique. Consequently, a detailed discussion of any particular feature selection technique is foregone.

In some implementations, the feature extraction module 204 provides a set of features to the modeling module 206. For each medical event that is to be modeled, the modeling module 206 generates a predictive model based on the respective set of features, and training data. In some examples, at least a portion of the training data can be provided from an epidemics knowledgebase 218, which provides historical data for respective medical events. In some examples, at least a portion of the training data is provided from source documents (e.g., patient medical records, health insurance forms, and the like). In some examples, the predictive model can be one of several types of predictive models. Example types of predictive models can include, without limitation, linear models, decision trees, time-series, and neural networks. In some examples, training of the predictive model is iterative. For example, a predictive model can be trained, and test data can be processed through the predictive model to determine an accuracy thereof. If the predictive model is not sufficiently accurate, the predictive model can be retrained. In some examples, retraining of the predictive model can include adjusting the features used for the predictive model (e.g., adding features, removing features, providing updated combinations of features), and/or adjusting the training data (e.g., removing training data, adding training data). Multiple techniques for training predictive models are known in the art. Implementations of the present disclosure can utilize any appropriate training technique. Consequently, a detailed discussion of any particular training technique is foregone.

The medical-event specific predictive models are provided to the prediction module 208. In accordance with implementations of the present disclosure, the prediction module 208 receives data from multiple data sources, and processes the data to provide an output 216 for a respective predictive model. In the example of FIG. 2, the multiple data sources include the epidemics knowledgebase 218, data from one or more facilities 220 (e.g., hospitals, clinics), data from one or more social media platforms 222 (e.g., social network posts), data from one or more authorities 224 (e.g., the Center for Disease Control (CDC) in the United States), and data from one or more trend observations 226 (e.g., Google Trends).

In some examples, the data from the multiple data sources is received in real-time. For example, as data is added to a data source, the data is provided to the prediction module 208 (e.g., a post is published to a social network, and, in response, the post (text data, image data) is provided to the prediction module 208). In some examples, the data from the multiple data sources is provided periodically. For example, data is provided at one or more predetermined intervals (e.g., hourly, daily, weekly). In some examples, the prediction module 208 requests data from one or more of the data sources ahead of providing a prediction (e.g., the prediction module 208 polls the data sources for recent data (data added to a data source since the data source was last polled).

In some implementations, data provided from one or more data sources can be specific to a medical event that is to be predicted. For example, data from one or more facilities can include intake forms, medical charts, medical claims, and the like that are relevant to a particular medical event. As another example, a social networking platform can include data related to hundreds or thousands of topics that are irrelevant to a particular medical event (e.g., posts sharing pictures of kittens), as well as data relevant to the particular medical event (e.g., posts asking about symptoms of Zika infection).

In some examples, data received from a data source can be filtered to remove data that is irrelevant to the medical event in question, and/or to remove any PII. In some examples, a request provided to the data source can indicate one or more medical events in question, such that the data can be filtered at the data source, prior to transmittal to the prediction module 208. In this manner, communication bandwidth can be conserved, and the prediction platform (e.g., the example architecture 200 of FIG. 2) can be leaner, as filtering functionality and corresponding computing resources can be foregone.

In some implementations, one or more predictions can be performed at predetermined time intervals (e.g., hourly, daily, weekly, monthly). In some examples, one or more predictions can be performed seasonally (e.g., flu season from October-May in the United States). In some examples, one or more predictions can be performed in response to one or more triggering events. For example, trend data (e.g., from the trend data source 226) can indicate an increase in data associated with a particular medical event (e.g., users submitting search queries regarding flu symptoms). In response, the prediction model for the particular medical event can be processed to provide a prediction regarding the medical event, in accordance with implementations of the present disclosure.

In some implementations, the predictive models can be location-specific, and/or can process data specific to a location. Example locations can include, without limitation, city, county, state, province, region, and country. For example, and with regard to location-specific predictive models, the predictive model can be trained using training data that is sourced from the location in question (e.g., hospitals, clinics located within the location). As another example, and with regard to location-specific data, the predictive model can be location agnostic, but can process location-specific data (e.g., data from the one or more data sources that originate within the location) to provide a location-relevant prediction. As another example, and with regard to location-specific data, the predictive model can be a location-specific predictive model, and can process location-specific data to provide an even more location-relevant prediction.

As described herein, the prediction module 208 provides the output 216 based on processing data from the one or more data sources through a respective predictive model. In some examples, the output 216 provides data indicating a likelihood of an occurrence of the respective medical event in a predetermined time period (e.g., the likelihood of a flu outbreak in the next 1 month). In some examples, the output 216 is provided as feedback to the modelling module 206. In some examples, the output 216 is provided to the action module 210, which can process the output 216 to perform one or more actions.

In some implementations, the action module 210 can compare the output 216 to one or more thresholds, and can perform one or more actions based thereon. In some examples, a first threshold can be provided, and, if the output 216 exceeds the first threshold, one or more actions of a first type can be performed. For example, the first threshold can represent an urgency, indicating that relatively urgent actions should be taken. For example, if the likelihood of the occurrence of the medical event exceeds the first threshold, one or more actions of the first type can be initiated in an effort to mitigate fallout of the medical event with the expectation that the medical event is likely to occur. Example actions can include transmitting urgent notifications to facilities (e.g., hospitals, clinics), pharmaceutical companies, local governments, and the like. Such entities can take relatively concrete actions to mitigate fallout from the medical event. For example, facilities can allocate resources in anticipation of patient intake, and a pharmaceutical company can adjust manufacturing schedules to increase the supply of available medicines. Other example actions can include sending notifications to a populace (e.g., text messages) that include a relatively urgent warning regarding the medical event, and providing appropriate resources (e.g., links to information on treatment, and/or avoiding contraction).

In some examples, a second threshold can be provided, and, if the output 216 exceeds the second threshold, but does not exceed the first threshold, one or more actions of a second type can be performed. For example, the second threshold can represent less urgency (e.g., than the first threshold), indicating that relatively less urgent actions should be taken. For example, if the likelihood of the occurrence of the medical event exceeds the second threshold, but does not exceed the first threshold, one or more actions of the second type can be initiated in an effort to mitigate occurrence of the medical event with the expectation that the medical event can be avoided. Example actions can include transmitting informational notifications to facilities (e.g., hospitals, clinics), local governments, institutions (e.g., schools, universities), a populace, and the like. Such entities can take actions to encourage avoidance of the medical event. For example, facilities can provide information (e.g., to patients) on how to avoid the medical event, symptoms of the medical event, and/or treatment (e.g., early treatment to avoid spread).

Although a first threshold and a second threshold are described herein, it is contemplated that implementations can include more or fewer thresholds, and respective levels of action, as appropriate.

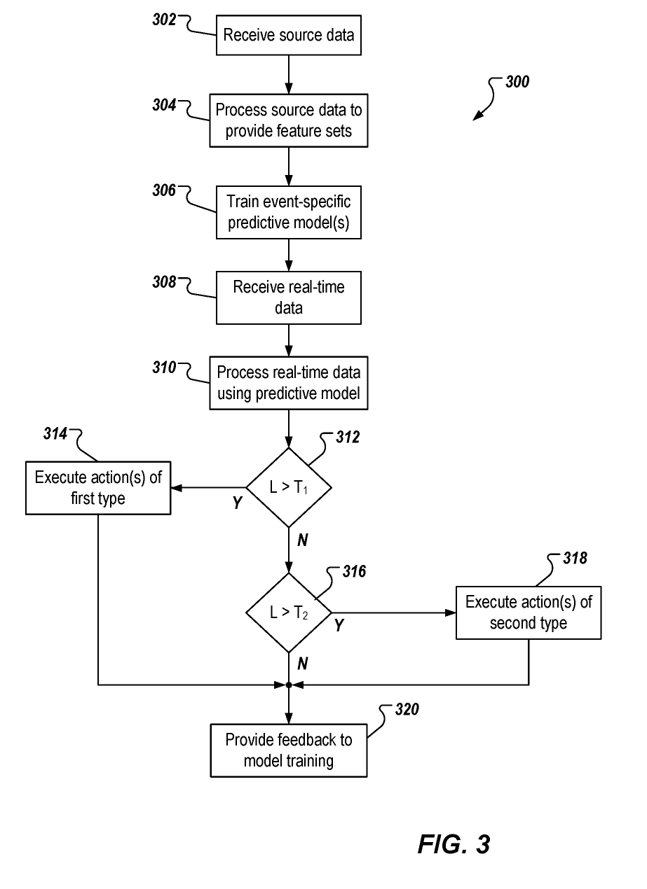

FIG. 3 depicts an example process 300 that can be executed in implementations of the present disclosure. In some examples, the example process 300 is provided using one or more computer-executable programs executed by one or more computing devices (e.g., the server system 108 of FIG. 1).

Source data is received (302). For example, and as described herein, source data is recorded in input documents 214 that are provided to the feature extraction module 204 of FIG. 2. In some examples, the input documents 214 are provided from source documents 212, each of which can be provided in a computer-readable format. The source data is processed to provide feature sets (304). For example, the feature extraction module 204 receives, and processes the input documents 214 to provide a set of features for each medical event that is to be modeled. One or more event-specific predictive models are trained (306). For example, and as described in further detail herein, for each medical event that is to be modeled, the modeling module 206 generates a predictive model based on the respective set of features, and training data.

Real-time data is received (308), and is processed through a predictive model (310). For example, and as described in further detail herein, the medical-event specific predictive models are provided to the prediction module 208, which receives data from multiple data sources, and processes the data to provide an output 216 for a respective predictive model. In some examples, the output 216 includes a likelihood (L) that a respective medical event will occur. It is determined whether the likelihood exceeds a first threshold (312). If the likelihood exceeds the first threshold, one or more actions of a first type are executed (314). Example actions can include transmitting urgent notifications to facilities (e.g., hospitals, clinics), pharmaceutical companies, local governments, and the like. Such entities can take relatively concrete actions to mitigate fallout from the medical event. If the likelihood does not exceed the first threshold, it is determined whether the likelihood exceeds a second threshold (316). If the likelihood exceeds the second threshold, one or more actions of a second type are executed (318). Example actions can include transmitting informational notifications to facilities (e.g., hospitals, clinics), local governments, institutions (e.g., schools, universities), a populace, and the like. Feedback is provided for subsequent training of predictive models (320).

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A method for machine-learned prediction of an occurrence of a medical event, the method being performed by one or more processors, and comprising:
receiving, by the one or more processors, source data comprising data representative of one or more medical events;
processing, by the one or more processors, the source data using one or more natural language processing (NLP) techniques to provide a plurality of feature sets;
providing, by the one or more processors, one or more event-specific predictive models based on the plurality of feature sets, each event-specific predictive model being specific to a particular medical event;
receiving, by the one or more processors, real-time data from one or more data sources, the real-time data being representative of occurring healthcare conditions;
processing, by the one or more processors, the real-time data using at least one event-specific predictive model associated with a medical event to provide a predictive output that indicates a likelihood of occurrence of the medical event; and
selectively broadcasting, by the one or more processors, one or more electronic messages to a plurality of remote devices at least partially based on the predictive output, at least one electronic message comprising data associated with the medical event, and data indicative of one or more of information and sources of information for mitigating exposure to the medical event.

2. The method of claim 1, wherein the predictive output is compared to one or more thresholds, and the electronic message is broadcast in response to the predictive output exceeding at least one threshold.

3. The method of claim 1, wherein an electronic message is provided as one of a first type and a second type based on at least one value of the predictive output.

4. The method of claim 1, wherein the one or more event-specific predictive models are provided based on training data.

5. The method of claim 1, wherein the source data is provided in two or more disparate formats, and is processed to a standardized format.

6. The method of claim 1, wherein the one or more event-specific predictive models are trained further based on one or more of updates to a knowledge base, and the predictive output.

7. One or more non-transitory computer-readable storage media coupled to one or more processors and having instructions stored thereon which, when executed by the one or more processors, cause the one or more processors to perform operations for machine-learned prediction of an occurrence of a medical event, the operations comprising:
receiving source data comprising data representative of one or more medical events;
processing the source data using one or more natural language processing (NLP) techniques to provide a plurality of feature sets;
providing one or more event-specific predictive models based on the plurality of feature sets, each event-specific predictive model being specific to a particular medical event;
receiving real-time data from one or more data sources, the real-time data being representative of occurring healthcare conditions;
processing the real-time data using at least one event-specific predictive model associated with a medical event to provide a predictive output that indicates a likelihood of occurrence of the medical event; and
selectively broadcasting one or more electronic messages to a plurality of remote devices at least partially based on the predictive output, at least one electronic message comprising data associated with the medical event, and data indicative of one or more of information and sources of information for mitigating exposure to the medical event.

8. The computer-readable storage media of claim 7, wherein the predictive output is compared to one or more thresholds, and the electronic message is broadcast in response to the predictive output exceeding at least one threshold.

9. The computer-readable storage media of claim 7, wherein an electronic message is provided as one of a first type and a second type based on at least one value of the predictive output.

10. The computer-readable storage media of claim 7, wherein the one or more event-specific predictive models are provided based on training data.

11. The computer-readable storage media of claim 7, wherein the source data is provided in two or more disparate formats, and is processed to a standardized format.

12. The computer-readable storage media of claim 7, wherein the one or more event-specific predictive models are trained further based on one or more of updates to a knowledge base, and the predictive output.

13. A system, comprising:
one or more processors; and
a computer-readable storage device coupled to the one or more processors and having instructions stored thereon which, when executed by the one or more processors, cause the one or more processors to perform operations for machine-learned prediction of an occurrence of a medical event, the operations comprising:
receiving source data comprising data representative of one or more medical events;
processing the source data using one or more natural language processing (NLP) techniques to provide a plurality of feature sets;
providing one or more event-specific predictive models based on the plurality of feature sets, each event-specific predictive model being specific to a particular medical event;
receiving real-time data from one or more data sources, the real-time data being representative of occurring healthcare conditions;
processing the real-time data using at least one event-specific predictive model associated with a medical event to provide a predictive output that indicates a likelihood of occurrence of the medical event; and
selectively broadcasting one or more electronic messages to a plurality of remote devices at least partially based on the predictive output, at least one electronic message comprising data associated with the medical event, and data indicative of one or more of information and sources of information for mitigating exposure to the medical event.

14. The system of claim 13, wherein the predictive output is compared to one or more thresholds, and the electronic message is broadcast in response to the predictive output exceeding at least one threshold.

15. The system of claim 13, wherein an electronic message is provided as one of a first type and a second type based on at least one value of the predictive output.

16. The system of claim 13, wherein the one or more event-specific predictive models are provided based on training data.

17. The system of claim 13, wherein the source data is provided in two or more disparate formats, and is processed to a standardized format.

18. The system of claim 13, wherein the one or more event-specific predictive models are trained further based on one or more of updates to a knowledge base, and the predictive output.
